(19) United States
(12) Patent Application Publication
(10) Pub. No.: US 2021/0208296 A1
(43) Pub. Date: Jul. 8, 2021

(54) Subterranean Formation Fault Prediction System

(71) Applicant: Landmark Graphics Corporation, Houston, TX (US)

(72) Inventors: Jesse Mathias Lomask, Houston, TX (US); Ze Yang, Houston, TX (US)

(21) Appl. No.: 16/070,611

(22) PCT Filed: Mar. 31, 2016
(86) PCT No.: PCT/US2016/025197

§ 371 Date: Jul. 17, 2018

(51) Int. Cl. G01V 1/34; G01V 1/30

(52) U.S. Cl. CPC G01V 1/345; G01V 2210/62; G01V 2210/65; G01V 1/306

(57) ABSTRACT

Systems and methods are provided for predicting a location of a fault in an area of interest of a subterranean formation by automatically determining a minimum-energy path between fault points received from a user and positioned on a seismic image of the area of interest. The seismic image of the area of interest may include fault indicators corresponding to potential faults. In some aspects, the minimum-energy path may be determined by tracing a path from one of the two fault points to the other fault points using segments of the fault indicators identified as requiring the least amount of energy to traverse a path between the selected fault points.

### TECHNICAL FIELD

The present disclosure relates generally to fault predictions in a subterranean formation adjacent to wellbores, and, more particularly, although not necessarily exclusively, to manipulating seismic images of a subterranean formation to determine fault locations.

### BACKGROUND

In hydrocarbon exploration, seismic energy may be generated and transmitted into a subterranean formation positioned in an area of interest of the subterranean formation. Seismic energy waves reflected or refracted off the formation may be recorded by acoustic receivers. The seismic waves reflected from the formation may be measured as seismic data and used to estimate the properties of the formation in the area of interest. For example, information including the travel time of the seismic waves from the formation to the receivers and the velocity of the seismic waves may be extracted from the seismic data and used to generate seismic images indicative of the formation assemblages.

### BRIEF DESCRIPTION OF THE DRAWINGS

FIG. 1 depicts an example of a two-dimensional slice of a seismic image corresponding to a subterranean formation according to an aspect of the present disclosure.

FIG. 2 depicts a minimum-energy path representing a fault in the subterranean formation of FIG. 1 according to an aspect of the present disclosure.

FIG. 3 is a flow chart of a process for automatically determining the minimum-energy path of FIG. 2 according to an aspect of the present disclosure.

FIG. 4 is a flow chart of an example of a process for tracing the minimum energy path of FIG. 2 according to an aspect of the present disclosure.

FIG. 5 depicts a portion of the seismic image of FIG. 1 including converted negative fault indicators in the subterranean formation according to an aspect of the present disclosure.

FIG. 6 depicts the seismic image of FIG. 5 including a visualization of the integrated energy of the subterranean formation according to aspects of the present disclosure.

FIG. 7 is a block diagram depicting an example of a system that may be used to generate the minimum-energy path of FIG. 2 according to an aspect of the present disclosure.

### DETAILED DESCRIPTION

Certain aspects and examples of the present disclosure relate to predicting a location of one or more faults in an area of interest of a subterranean formation by determining a minimum-energy path between two fault points of the subterranean formation. In some aspects, a system may calculate an energy path from one of the two fault points to multiple fault points in the area of interest. Each calculated energy path may serve as a potential segment for connecting the two fault points to generate the minimum-energy path. In some aspects, the energy associated with traversing the calculated energy paths may be identified. The minimum-energy path may be determined by tracing a path from one of the two fault points to the other fault points using the segments of the fault indicators having the least amount of energy in the area of interest.

In some aspects, the area of interest of the subterranean formation may be visually represented as a seismic image using seismic data associated with the subterranean formation. The seismic image corresponding to the seismic data may include a number of fault indicators representing potential faults in the subterranean formation. In some aspects, the brightness or clarity of the potential fault points that make up the fault indicators may correspond to a likelihood of the corresponding line representing an actual fault in the area of interest. The brightness of the potential fault points may further correspond to an electric potential associated with traversing the path between the potential fault points. In some aspects, the level of brightness may be inversely related to the electric potential to allow the brighter fault indicators to represent lower energy paths. A system according to some aspects of the present disclosure may determine the minimum-energy path based on the brightness of the potential fault points between two selected fault points on the seismic image.

A system according to some aspects may allow faults in an area of interest of a subterranean formation to be automatically determined based on a minimal input from a user. For example, a user may input only two fault points and the system may quickly generate an accurate representation of a fault between the two fault points without any additional input from the user. In some aspects, the system may also allow for modifications to the representation of the fault in response to an input of one or more additional fault points on the seismic image. The system according to some aspects may be used to distinguish between actual faults in the subterranean formation and potential fault points or fault indicators on a seismic image corresponding to false readings of a fault that may be caused by uncertainties in the properties of the subterranean formation. Knowledge of the location of actual faults in a subterranean formation may be useful for many purposes, including, but not limited to, planning and determining locations for wellbore and for geological modeling of the subterranean formation to determine the flow of fluid in the faults.

These illustrative examples are provided to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. The various figures described below depict examples of implementations for the present disclosure, but should not be used to limit the present disclosure.

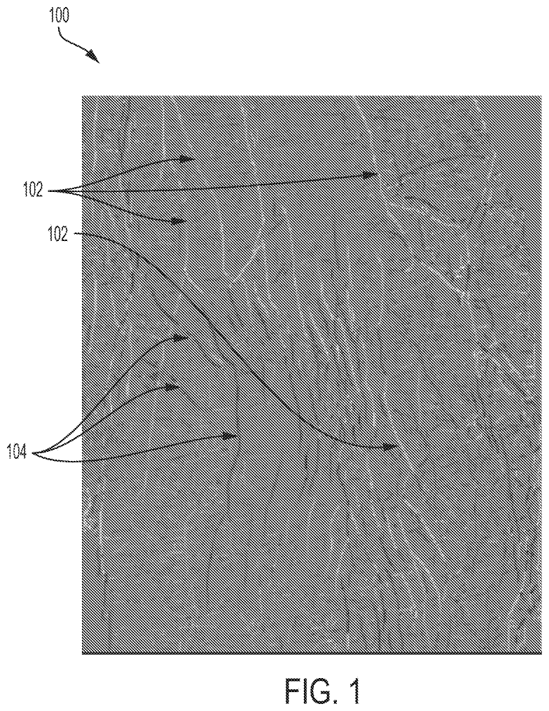

FIG. 1 depicts an example of a two-dimensional slice of a seismic image 100 corresponding to a subterranean formation according to an aspect of the present disclosure. In some aspects, the seismic image 100 may correspond to a portion of a three-dimensional seismic image and visually represent an area of interest of the subterranean formation. The seismic image may be generated from a seismic inversion that converts reflectivity data corresponding to a measurement of seismic waves reflecting or refracting off the subterranean formation into an image representative of rock and fluid properties of the subterranean formation. The seismic image 100 may include fault attribute data corresponding to the area of interest of the subterranean formation. The fault attribute data may be derived from various quantitative workflows, including, but not limited to, entropy, semblance, antracking, of seismic traces making up the seismic image 100 to determine indicators in the seismic data that may correspond to potential faults in the seismic image 100. The potential faults in the seismic data are represented by fault indicators 102, 104 in the seismic image 100. In some aspects, the fault indicators 102, 104 may correspond to seismic attributes including, but not limited to, coherence, semblance, discontinuity, cross-correlation, dip, or dip estimation residual. In additional and alternative aspects, the fault indicators 102, 104 be a result of the curvature of the subterranean formation corresponding to changes (e.g., breaks, bends) in the formation at different points in the area of interest. The fault indicators 102 are depicted as light curvilinear lines in the seismic image 100 and may represent positive fault indicators corresponding to a positive tracking volume. The fault indicators 104 are depicted as dark curvilinear lines in the seismic image 100 and may represent negative fault indicators corresponding to a negative tracking volume. In some aspects, the seismic image 100 may be a fault likelihood attribute and include fault attribute data corresponding to the orientation of faults in the subterranean formation. The orientation of the fault in the subterranean formation may provide additional location information to increase the accuracy of predictions of the faults in the area of interest.

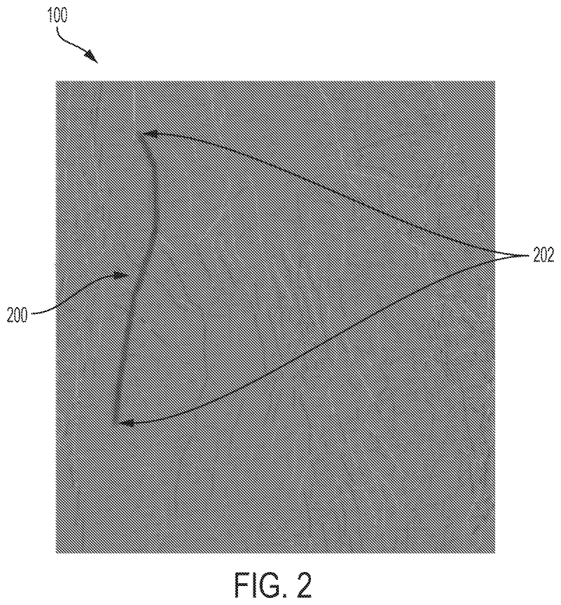

FIG. 2 depicts a minimum-energy path 200 corresponding to a fault in the area of interest of the subterranean formation represented by the seismic image 100 according to an aspect of the present disclosure. The minimum-energy path 200 may be generated using the fault indicators 102, 104 in the seismic image 100. In some aspects, the minimum-energy path 200 may be overlaid onto the seismic image 100 and include portions of the fault indicators 102, 104 that likely correspond to an actual fault in the subterranean formation. The minimum-energy path 200 may be bounded by fault endpoints 202. In some aspects, the fault endpoints 202 may represent points in the seismic image selected as representative of actual locations of a portion of a fault in the subterranean formation. In some aspects, the minimum-energy path 200 may characterize a pathway between the fault endpoints 202 requiring the least amount of energy to traverse the subterranean formation between the fault endpoints 202. In one example, the energy may be comparable to “navigation” from one fault endpoint 202 to the other fault endpoint 202 through multiple fault points defining the fault indicators 102, 104. The non-uniform structure of the subterranean formation in the area of interest between the fault endpoints 202 may cause a resistance to navigating between the endpoints 202. For example, a higher level of energy may be required to overcome the resistance caused by the subterranean formation along certain paths and a lower level of energy may be required to traverse paths having less resistance. The resistance along the various paths may vary with changes in the structure of the subterranean formation. A fault in the subterranean formation may correspond to a break or bend in the subterranean formation that reduces or removes the resistance to navigation. As various paths are considered between the fault endpoints 202, the pathway corresponding to the fault may require the least amount of energy to navigate between the fault endpoints 202. As such, the minimum-energy path 200 may correspond to an actual fault in the subterranean formation providing minimal energy to navigate between the fault endpoints 202. The minimal resistance in the minimum-energy path 200 may allow the path corresponding to the actual fault to be traversed with minimal to no resistance.

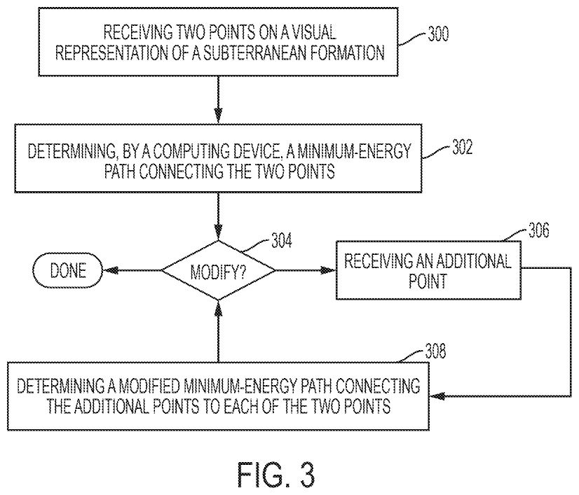

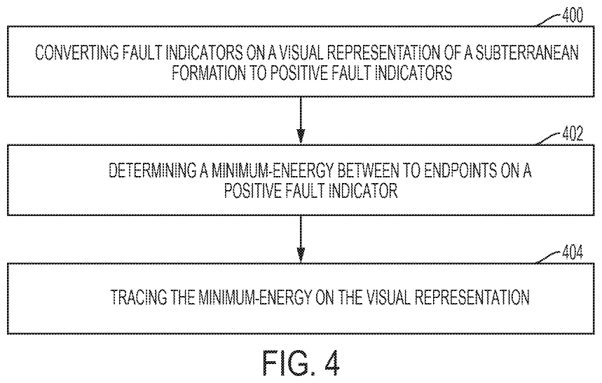

FIGS. 3 and 4 are flow charts of processes for generating the minimum-energy path 200 of FIG. 2 according to aspects of the present disclosure. The processes may be described with respect to the seismic image 100 of FIGS. 1 and 2, unless otherwise indicated, although other implementations are possible without departing from the scope of the present disclosure.

In block 300 of FIG. 3, the fault endpoints 202 are received. In some aspects, the fault endpoints 202 may be selected by an observer of the seismic image 100. In additional and alternative aspects, the fault endpoints 202 may represent points of the seismic image 100 that the observer indicates as corresponding to a position of a portion of a fault in the area of interest of the subterranean formation represented by the seismic image 100. The fault endpoints 202 may be selected on one or more of the fault indicators 102, 104 on the seismic image 100.

In block 302, the minimum-energy path 200 connecting the fault endpoints 202 may be determined by a computing device. The minimum-energy path 200 may include a curvilinear path corresponding to a fault in the subterranean formation represented by the seismic image 100. In some aspects, the minimum-energy path 200 may be determined by tracing the minimum-energy path 200 and overlaying the minimum-energy path 200 onto the seismic image 100. In additional aspects, the minimum-energy path 200 may be overlaid onto one or more of the fault indicators 102, 104 on the seismic image 100.

FIG. 4 is a flow chart of an example of a process for tracing the minimum-energy path 200 according to an aspect of the present disclosure. In block 400, the seismic image 100 is modified by converting fault indicators 104 to positive fault indicators. In some aspects, the absolute values of the seismic image 100 may be determined such that the fault indicators 102 remain positive fault indicators and the fault indicators 104 are converted to positive fault indicators. The fault indicators 104 may be replaced in the seismic image 100 with positive fault indicators of the same magnitude. In some aspects, the absolute value of the fault indicators 104 or the seismic image 100 may be taken using numerical values associated with the seismic data corresponding to the fault indicators 104 or the seismic image 100, generally. In other aspects, the numerical values associated with the fault indicators 102, 104 may be squared to convert the negative fault indicators 104 to positive fault indicators. Converting the fault indicators 104 to positive fault indicators may allow the relative magnitude of the fault indicators 102, 104 to be determined to identify a level of resistance of energy caused by properties of the subterranean formation proximate to the fault indicators 102, 104.

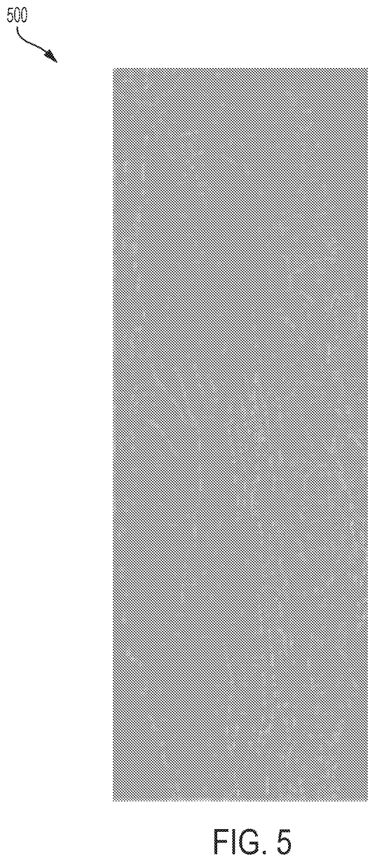

FIG. 5 depicts a seismic image 500 including converted negative fault indicators in the subterranean formation according to an aspect of the present disclosure. The seismic image 500 may be a portion of the seismic image 100 of FIGS. 1-2 and may include only positive fault indicators. The positive fault indicators may be depicted as the light curvilinear lines in the seismic image 500 and may correspond to the fault indicators 102, 104 of the seismic image 100 of FIGS. 1 and 2.

Returning to FIG. 4, in block 402, energy paths along the positive fault indicators may be used to determine a minimum-energy path. In some aspects, the fault indicators may be assigned an electric potential. A stronger, or brighter, fault indicator may correspond to a lower electric potential assigned to the fault indicator. A weaker, or duller, fault indicator may correspond to a higher electric potential. For example, the level of brightness of the fault points making up the fault indicators on the seismic image 100 may be inversely proportional to the energy level so the brighter fault indicators represent lower energy paths. The first fault endpoint 202 selected by the user may be assigned zero energy. The second fault endpoint 202 selected by the user may be assigned a high-energy point. The minimum-energy path may be traced from the second fault endpoint 202 to the first fault endpoint 202 along the energy paths along the fault indicators having the least amount of energy (e.g., the brightest potential fault points making up the fault indicator). The energy paths may be generated using known numerical analysis methods. Non-limiting examples of methods for determining the energy paths may include fast marching methods for solving the eikonal equation, Dijkstra's algorithm, fast sweeping methods, or label-correcting methods.

Using the comparison of energy to “navigation” described in FIG. 2, the energy paths may correspond to various paths for navigating along the fault indicators 102, 104 of the seismic image 100 according to other aspects. The fault indicators may correspond to the velocity, where the minimum-energy path, the fault indicator requiring the least amount of energy to navigate between the fault endpoints 202, represents the highest velocity.

In block 404, the minimum-energy path 200 may be traced between the fault endpoints 202. In some aspects, the minimum-energy path 200 may be traced starting from the second fault endpoint 202 selected to the first fault endpoint 202 selected along the identified minimum-energy path.

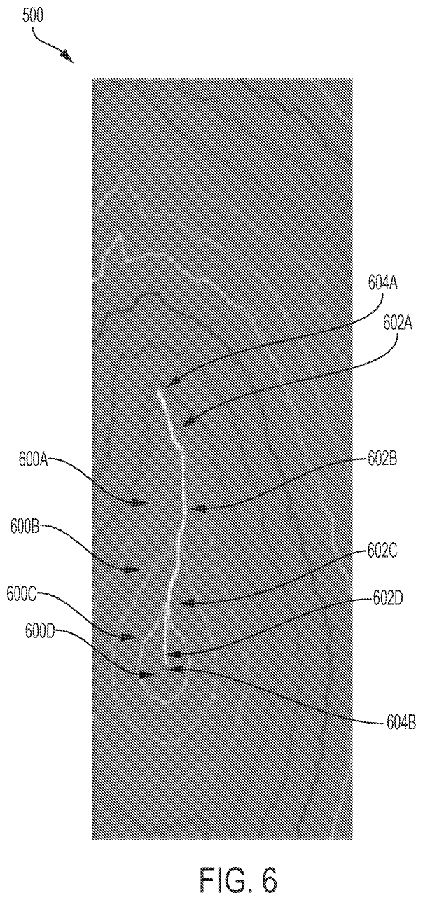

FIG. 6 depicts the seismic image 500 of FIG. 5 including contoured regions 600A-D visualizing sets of energy paths between the fault endpoints 202. In some aspects, the minimum-energy path may include minimum-energy segments 602A-D between the fault endpoints 202 corresponding to the contoured regions 600A-D. In some aspects, the minimum-energy segments 602A-D may collectively correspond to the minimum-energy path 200 of FIG. 2. The fault endpoint 604A is included in the region 600A and may represent the second fault endpoint selected by the user. The contoured regions 600A-D are centered on the fault endpoint 604B positioned in region 600D and representing the first fault endpoint selected by the user. In some aspects, the minimum-energy path may be traced from fault endpoint 604A to fault endpoint 604B along the minimum-energy segments 602A-D. In some aspects, the minimum-energy segment 602A may correspond to a least-energy path between the fault endpoint 604A and the inner boundary of the region 600A requiring the least amount of energy to navigate or traverse. The minimum-energy segment 602B may be similarly correspond to a least-energy path between the fault endpoint of the minimum-energy segment 602A positioned on the inner boundary of region 600A and the inner boundary of region 600B. The minimum-energy segment 602C may correspond to a least-energy path between the fault endpoint of the minimum-energy segment 602B positioned on the inner boundary of region 600B and the inner boundary of region 600C. The minimum-energy segment 602D may correspond to a least-energy path between the fault endpoint of the minimum-energy segment 602C positioned on the inner boundary of region 600C and the fault endpoint 604B. The minimum-energy path between the fault endpoints 604A-B may correspond to a fault in the area of interest of the subterranean formation represented by the seismic image 500. Although the contoured regions 600A-D are shown in FIG. 6 on the seismic image 500, the contoured regions 600A-D are representative of intermediary data in calculating the minimum-energy path and may not be displayable to the user.

Returning to FIG. 3, in block 304, a decision is made on whether to modify the minimum-energy path. If a decision is made to modify the minimum-energy path, the process proceeds to block 306 where an additional fault point is received. In some point, the additional fault point may correspond to a location on the seismic image 500 proximate to the minimum-energy path. For example, the additional fault point may correspond to a midpoint between the two fault points. In block 308, a modified minimum-energy path may be determined by connecting the additional point to each of the two points. In some aspects, the modified minimum-energy path may be determined using a process similar to the process described in blocks 402, 404. But, the minimum-energy path may be traced from the additional point to each of the two fault points to create a curvilinear path connecting the two fault points and the additional point. Subsequent to determining the modified minimum-energy path as described in block 308, additional fault points may be added to further modify the minimum-energy path to connect to each of the received fault points.

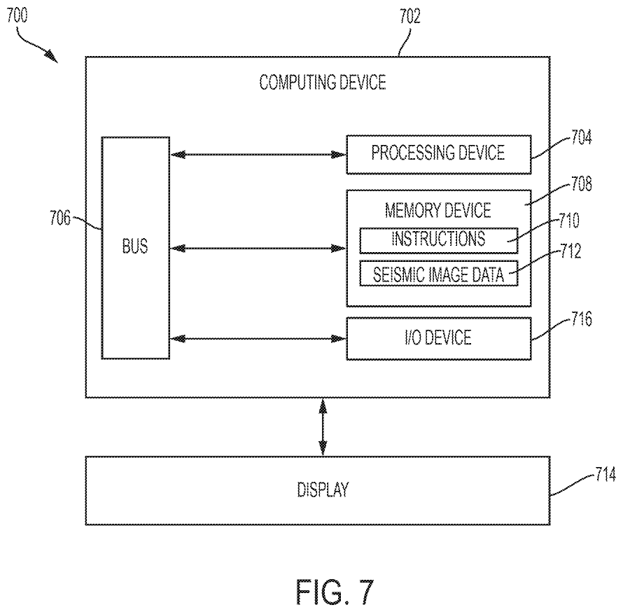

FIG. 7 is a block diagram depicting an example of a system 700 that may be used to generate the minimum-energy path 200 of FIG. 2 according to an aspect of the present disclosure. The system 700 includes a computing device 702. In some aspects, the computing device 702 may be positioned at a surface of the earth above the subterranean formation represented by the seismic image 100. In other aspects, the computing device 702 may be positioned in a remote location away from the subterranean formation. The computing device 702 may include a processing device 704, a bus 706, and a memory device 708. The processing device 704 may execute one or more operations for generating the minimum-energy path 200 of FIG. 2. The processing device 704 may execute instructions 710 stored in the memory device 708 to perform the operations. The processing device 704 may include one processing device or multiple processing devices. Non-limiting examples of the processing device 704 may include a field-programmable gate array (“FPGA”), an application-specific integrated circuit (“ASIC”), a microprocessor, etc. In some aspects, the processing device 704 may also include specialized hardware for manipulating and displaying images, such as a graphics processing unit (“GPU”). The graphics processing unit may be included on a video card or a printed circuit board of the computing device 702 and may be provide sufficient processing power for manipulating seismic images to generate the minimum-energy path 200. The memory device 708 may include any type of storage device that retains stored information when powered off. Non-limiting examples of the memory device 708 may include electrically erasable and programmable read-only memory (“EEPROM”), a flash memory, or any other type of non-volatile memory.

In some examples, at least a portion of the memory device 708 may include a computer-readable medium from which the processing device 704 can read the instructions 710. A computer-readable medium may include electronic, optical, magnetic, or other storage devices capable of providing the processing device 704 with computer-readable instructions or other program code. Non-limiting examples of a computer-readable medium include, but are not limited to, magnetic disks, memory chips, ROM, random-access memory (“RAM”), an ASIC, a configured processor, optical storage, or any other medium from which a compute processor can read the instructions 710. The instructions 710 may include processor-specific instructions generated by a compiler or an interpreter from code written in any suitable computer-programming language, including, for example, C, C+++, C#, etc. In some examples, the instructions 710 may include one or more equations usable for generating the minimum-energy path 200 of FIG. 1. For example, instructions 710 may include algorithms such as a fast-marching algorithm for solving the eikonal equation, Dijkstra's algorithm, fast-sweeping algorithms, label-correcting algorithms, and hybrids thereof. In some aspects, the algorithms may be used to manipulate or interpret seismic image data 712 stored in a portion of the memory device 708. The seismic image data 712 may include image data generated from seismic data corresponding to subterranean formation. In some aspects, the seismic image data 712 may include data corresponding two-dimensional, three-dimensional, or four-dimensional seismic images of the subterranean formation.

The instructions 710 may also include code for generating user interfaces that, when executed by the processing device 704, may cause the computing device 702: to display the user interfaces on a display device 714. The display device 714 may be coupled to the computing device 702 via an input/output (I/O) device 716 that may allow a user of the computing device 702 to input information or selections using the user interfaces. In some aspects, the display device 714 may include any CRT, LCD, OLED, or other device for displaying interfaces generated by the processing device 704.

In some aspects, systems and methods may be provided according to one or more of the following examples:

Example #1: A method may include receiving fault points of a visual representation associated with a fault in a subterranean formation. The method may also include determining, by a computing device, a minimum-energy path on the visual representation between the fault points to connect the fault points and that corresponds to the fault.

Example #2: The method of Example #1 may feature the visual representation including fault indicators corresponding to potential faults in the subterranean formation. The method may also feature the minimum-energy path being overlaid onto at least one of the fault indicators between the fault points.

Example #3: The method of Examples #1-2 may feature the fault points including a first endpoint and a second endpoint. The method may also feature determining the minimum-energy path to include converting fault indicators in the visual representation corresponding to a set of potential fault points in the subterranean formation to positive fault indicators. The method may also feature determining the minimum-energy path to include calculating the minimum-energy path between the fault points. The method may also feature determining the minimum-energy path to include tracing, on the visual representation, the minimum-energy path from the second endpoint to the first endpoint.

Example #4: The method of Examples #1-3 may feature converting the fault indicators in the visual representation to positive fault indicators to include determining an absolute value of fault indicator values corresponding to the fault indicators.

Example #5: The method of Examples #1-3 may feature converting the fault indicators in the visual representation to positive fault indicators to include determining a square of fault indicator values corresponding to the fault indicators.

Example #6: The method of Examples #1-5 may feature the first endpoint corresponding to a first user selection of a first fault point on the visual representation. The method may also feature the second endpoint corresponding to a second user selection of a second fault point on the visual representation occurring after the first user selection.

Example #7: The method of Examples #1-6 may feature the visual representation including a fault likelihood attribute having fault attribute data corresponding to an orientation of the fault.

Example #8: The method of Examples #1-7 may feature receiving an additional fault point of the visual representation. The method may also feature determining the minimum-energy path between the fault points to include tracing the minimum-energy path from the additional fault point to each of the fault points.

Example #9: The method of Examples #1-8 may feature an energy level associated with the minimum-energy path being inversely related to a brightness level of one or more fault indicators on the visual representation defining the minimum-energy path.

Example #10: A computing device may include a processing device. The computing device may also include a memory device in which instructions executable by the processing device are stored for causing the processing device to receive fault points of a visual representation associated with a fault in a subterranean formation. The memory device may also include instructions executable by the processing device for causing the processing device to determine a minimum-energy path between the fault points to connect the fault points and that corresponds to the fault.

Example #11: The computing device of Example #10 may feature the visual representation including fault indicators corresponding to potential faults in the subterranean formation. The memory device may also include instructions executable by the processing device for causing the processing device to overlay the minimum-energy path onto at least one of the fault indicators between the fault points.

Example #12: The computing device of Examples #10-11 may feature the fault points including a first endpoint and a second endpoint. The memory device may also include instructions executable by the processing device for causing the processing device to determine the minimum-energy path by converting fault indicators in the visual representation corresponding to a set of potential fault points in the subterranean formation to positive fault indicators. The memory device may also include instructions executable by the processing device for causing the processing device to determine the minimum-energy path by calculating the minimum-energy path between the fault points. The memory device may also include instructions executable by the processing device for causing the processing device to determine the minimum-energy path by tracing, on the visual representation, the minimum-energy path from the second endpoint to the first.

Example #13: The computing device of Examples #10-12 may feature the memory device also including instructions executable by the processing device for causing the processing device to convert the fault indicators in the visual representation to positive fault indicators by determining an absolute value of fault indicator values corresponding to the fault indicators.

Example #14: The computing device of Examples #10-12 may feature the memory device also including instructions executable by the processing device for causing the processing device to convert the fault indicators in the visual representation to positive fault indicators by determining a square of fault indicator values corresponding to the fault indicators.

Example #15: The computing device of Examples #10-14 may also feature the first endpoint corresponding to a first user selection of a first fault point on the visual representation. The computing device may also feature the second endpoint corresponding to a second user selection of a second fault point on the visual representation occurring after the first user selection.

Example #16: The computing device of Examples #10-15 may feature the visual representation including a fault likelihood attribute having fault attribute data corresponding to an orientation of the fault.

Example #17: The computing device of Examples #10-16 may also feature the memory device also including instructions executable by the processing device for causing the processing device to receive an additional fault point of the visual representation. The memory device may also include instructions executable by the processing device for causing the processing device to determine the minimum-energy path between the fault points by tracing the minimum-energy path from the additional fault point to each of the fault points.

Example #18: A system may include a computing device comprising a processing device. The computing device may also include a memory device in which instructions executable by the processing device are stored for causing the processing device to receive fault points of a visual representation associated with a fault in a subterranean formation. The fault points may include a first endpoint and a second endpoint. The visual representation may include one or more fault indicators corresponding to potential faults in the subterranean formation. The memory device may also include instructions executable by the processing device for causing the processing device to convert the one or more fault indicators to one or more positive fault indicators. The memory device may also include instructions executable by the processing device for causing the processing device to calculate a minimum-energy path between the fault points and corresponding to the fault. The memory device may also include instructions executable by the processing device for causing the processing device to trace, on the visual representation, the minimum-energy path from the second endpoint to the first. The memory device may also include instructions executable by the processing device for causing the processing device to a display device coupled to the computing device for displaying the visual representation and the minimum-energy path overlaid onto the visual representation.

Example #19: The system of Example #18 may feature the first endpoint corresponding to a first user selection of a first fault point on the visual representation. The system may also feature the second endpoint corresponding to a second user selection of a second fault point on the visual representation occurring after the first user selection.

Example #20: The system of Examples #18-19 may feature the memory device further including instructions executable by the processing device for causing the processing device to receive an additional fault point of the visual representation. The memory device may also include instructions executable by the processing device for causing the processing device to determine the minimum-energy path between the fault points by tracing the minimum-energy path from the additional fault point to each of the fault points.

The foregoing description of the examples, including illustrated examples, has been presented only for the purpose of illustration and description and is not intended to be exhaustive or to limit the subject matter to the precise forms disclosed. Numerous modifications, adaptations, uses, and installations thereof can be apparent to those skilled in the art without departing from the scope of this disclosure. The illustrative examples described above are given to introduce the reader to the general subject matter discussed here and are not intended to limit the scope of the disclosed concepts.

What is claimed is:

1. A method, comprising:
receiving fault points of a visual representation associated with a fault in a subterranean formation; and
determining, by a computing device, a minimum-energy path on the visual representation between the fault points to connect the fault points and that corresponds to the fault.

2. The method of claim 1, wherein the visual representation includes fault indicators corresponding to potential faults in the subterranean formation,
wherein the minimum-energy path is overlaid onto at least one of the fault indicators between the fault points.

3. The method of claim 1, wherein the fault points include a first endpoint and a second endpoint,
wherein determining the minimum-energy path includes:
converting fault indicators in the visual representation corresponding to a set of potential fault points in the subterranean formation to positive fault indicators;
calculating the minimum-energy path between the fault points; and
tracing, on the visual representation, the minimum-energy path from the second endpoint to the first endpoint.

4. The method of claim 3, wherein converting the fault indicators in the visual representation to positive fault indicators includes determining an absolute value of fault indicator values corresponding to the fault indicators.

5. The method of claim 3, wherein converting the fault indicators in the visual representation to positive fault indicators includes determining a square of fault indicator values corresponding to the fault indicators.

6. The method of claim 3, wherein the first endpoint corresponds to a first user selection of a first fault point on the visual representation and the second endpoint corresponds to a second user selection of a second fault point on the visual representation occurring after the first user selection.

7. The method of claim 1, wherein the visual representation includes a fault likelihood attribute having fault attribute data corresponding to an orientation of the fault.

8. The method of claim 1, further including receiving an additional fault point of the visual representation,
wherein determining the minimum-energy path between the fault points includes tracing the minimum-energy path from the additional fault point to each of the fault points.

9. The method of claim 1, wherein an energy level associated with the minimum-energy path is inversely related to a brightness level of one or more fault indicators on the visual representation defining the minimum-energy path.

10. A computing device, comprising:
a processing device; and
a memory device in which instructions executable by the processing device are stored for causing the processing device to:
receive fault points of a visual representation associated with a fault in a subterranean formation; and
determine a minimum-energy path between the fault points to connect the fault points and that corresponds to the fault.

11. The computing device of claim 10, wherein the visual representation includes fault indicators corresponding to potential faults in the subterranean formation,
wherein the memory device further comprises instructions executable by the processing device for causing the processing device to overlay the minimum-energy path onto at least one of the fault indicators between the fault points.

12. The computing device of claim 10, wherein the fault points include a first endpoint and a second endpoint,
wherein the memory device further comprises instructions executable by the processing device for causing the processing device to determine the minimum-energy path by:
converting fault indicators in the visual representation corresponding to a set of potential fault points in the subterranean formation to positive fault indicators;
calculating the minimum-energy path between the fault points; and
tracing, on the visual representation, the minimum-energy path from the second endpoint to the first.

13. The computing device of claim 12, wherein the memory device further comprises instructions executable by the processing device for causing the processing device to convert the fault indicators in the visual representation to positive fault indicators by determining an absolute value of fault indicator values corresponding to the fault indicators.

14. The computing device of claim 12, wherein the memory device further comprises instructions executable by the processing device for causing the processing device to convert the fault indicators in the visual representation to positive fault indicators by determining a square of fault indicator values corresponding to the fault indicators.

15. The computing device of claim 12, wherein the first endpoint corresponds to a first user selection of a first fault point on the visual representation and the second endpoint corresponds to a second user selection of a second fault point on the visual representation occurring after the first user selection.

16. The computing device of claim 10, wherein the visual representation includes a fault likelihood attribute having fault attribute data corresponding to an orientation of the fault.

17. The computing device of claim 10, wherein the memory device further comprises instructions executable by the processing device for causing the processing device to:
receive an additional fault point of the visual representation; and
determine the minimum-energy path between the fault points by tracing the minimum-energy path from the additional fault point to each of the fault points.

18. A system, comprising:
a computing device, comprising:
a processing device;
a memory device in which instructions executable by the processing device are stored for causing the processing device to:
receive fault points of a visual representation associated with a fault in a subterranean formation, the fault points including a first endpoint and a second endpoint, the visual representation including one or more fault indicators corresponding to potential faults in the subterranean formation;
convert the one or more fault indicators to one or more positive fault indicators;
calculate a minimum-energy path between the fault points and corresponding to the fault; and
trace, on the visual representation, the minimum-energy path from the second endpoint to the first; and
a display device coupled to the computing device for displaying the visual representation and the minimum-energy path overlaid onto the visual representation.

19. The system of claim 18, wherein the first endpoint corresponds to a first user selection of a first fault point on the visual representation and the second endpoint corresponds to a second user selection of a second fault point on the visual representation occurring after the first user selection.

20. The system of claim 18, wherein the memory device further comprises instructions executable by the processing device for causing the processing device to:
receive an additional fault point of the visual representation; and
determine the minimum-energy path between the fault points by tracing the minimum-energy path from the additional fault point to each of the fault points.
